(19) United States
(12) Patent Application Publication
(10) Pub. No.: US 2014/0298457 A1
(43) Pub. Date: Oct. 2, 2014

(54) METHOD AND APPARATUS FOR COLLECTING HARMFUL INFORMATION USING BIG DATA ANALYSIS

(71) Applicant: ELECTRONICS AND TELECOMMUNICATIONS RESEARCH INSTITUTE, Daejeon (KR)

(72) Inventors: Wang-Bong LEE, Daejeon (KR); Sang-Kil PARK, Daejeon (KR)

(73) Assignee: ELECTRONICS AND TELECOMMUNICATIONS RESEARCH INSTITUTE, Daejeon (KR)

(21) Appl. No.: 14/084,461

(22) Filed: Nov. 19, 2013

(30) Foreign Application Priority Data
Mar. 26, 2013 (KR) 10-2013-0032390

(51) Int. Cl. H04L 29/06

(52) U.S. Cl. CPC H04L 63/1408
USPC 726/22

(57) ABSTRACT

Disclosed are a method and apparatus for collecting harmful information that analyze a plurality of packets collected in real time from a network and collect information on harmful sites. The harmful information collecting method includes receiving a plurality of packets collected by at least one packet collecting unit, analyzing whether the received packets include harmful information, extracting information on harmful sites from which corresponding packets are transmitted if the analyzed packets include harmful information, and storing the extracted information on harmful sites in a database.

### CROSS-REFERENCE TO RELATED APPLICATION

This application claims the benefit under 35 U.S.C. §119(a) of Korean Patent Application No. 10-2013-0032390, filed on Mar. 26, 2013, in the Korean Intellectual Property Office, the entire disclosure of which is incorporated herein by reference for all purposes.

### BACKGROUND

1. Field

The following description relates to a data analysis method, and more particularly, to an apparatus and method for collecting harmful information using data analysis.

2. Description of the Related Art

Development of the Internet has led to harmful information such as illegal adult material being easily exposed on the Internet. Such harmful information is easily obtained, since the harmful information can be accessed simply by typing an address of a corresponding site in an Internet search address field.

Accordingly, nowadays efforts are being made to expose and close sites dealing with harmful information and to fundamentally block access to keywords of the corresponding sites. Consequently, operators of harmful sites are taking measures such as changing access addresses or moving access addresses to foreign countries in order to avoid regulations.

As a conventional method for extracting an illegal harmful site, there is a method for extracting information on harmful site by analyzing stored packets or data. Otherwise, information on harmful site is updated pursuant to a report from a manager or a user. Since it is impossible to update information instantly according to such a conventional method, harmful sites cannot be dealt with in real time.

Related conventional technology includes Korean Patent No. 10-0835820 (May 30, 2008).

### SUMMARY The following description relates to a method and apparatus for collecting harmful site information by analyzing a plurality of packets collected from a network in real time.

In one general aspect, a harmful information collecting method includes receiving a plurality of packets collected by at least one packet collecting unit; analyzing whether the received packets include harmful information; extracting information on harmful sites from which corresponding packets are transmitted if the analyzed packets include harmful information; and storing the extracted information on harmful sites in a database.

In one general aspect, the receiving of the packets in the harmful information collecting method includes receiving metadata of the packets collected under collection control based on a predetermined policy by at least one packet collecting unit in real time.

In one general aspect, the analyzing of the packets in the harmful information collecting method includes reassembling the received packets in predetermined units and analyzing whether the reassembled packets include harmful information.

In one general aspect, the analyzing of the packets in the harmful information collecting method includes analyzing harmfulness with respect to any one of text data, multimedia data, or image data included in the reassembled packets.

In one general aspect, the harmful information collecting method further includes transmitting the information on harmful sites stored in the database to at least one security apparatus.

In one general aspect, a harmful information collecting apparatus includes at least one packet collecting unit that collects a plurality of packets from at least one network, a packet analyzing unit that receives the plurality of packets collected by the at least one packet collecting unit, analyzes the received packets, and extracts information on harmful sites from which corresponding packets are transmitted if the analyzed packets include harmful information, and a database that stores the extracted information on harmful sites.

In one general aspect, the packet collecting unit of the harmful information collecting apparatus includes a collection control unit that controls a packet collecting interface according to a predetermined policy, and the packet collecting interface that collects packets under the control of the collection control unit, extracts metadata of the collected packets, and transmits the extracted metadata to the packet analyzing unit.

In one general aspect, the packet analyzing unit of the harmful information collecting apparatus includes a packet interface that receives a plurality of packets from at least one packet collecting unit, a packet reassembling unit that reassembles the received packets in predetermined units to analyze the received packets, a packet harmfulness analyzing unit that analyzes harmfulness of the reassembled packets, and a harmful site data extracting unit that extracts information on sites from which corresponding packets are transmitted, if the analyzed reassembled packets include harmful information.

In one general aspect, the packet harmfulness analyzing unit of the harmful information collecting apparatus includes a text data analyzing unit that analyzes harmfulness with respect to text data included in the reassembled packets, a multimedia data analyzing unit that analyzes harmfulness with respect to multimedia data included in the reassembled packets, and an image data analyzing unit that analyzes harmfulness with respect to image data included in the reassembled packets.

In one general aspect, the packet interface of the harmful information collecting apparatus transmits the information on harmful sites stored in the database to at least one security apparatus.

### BRIEF DESCRIPTION OF THE DRAWINGS

FIG. 1 is a flowchart illustrating a harmful information collecting method according to an embodiment of the present invention.

FIG. 2 is a flowchart illustrating a harmful information collecting method according to another embodiment of the present invention.

FIG. 3 is a block diagram illustrating a harmful information collecting apparatus according to an embodiment of the present invention.

FIG. 4 is a block diagram illustrating a packet collecting unit according to an embodiment of the present invention.

FIG. 5 is a block diagram illustrating a packet analyzing unit according to an embodiment of the present invention.

FIG. 6 is a block diagram illustrating a packet harmfulness analyzing unit according to an embodiment of the present invention.

FIG. 7 is a diagram illustrating a structure of a harmful information collecting apparatus according to an embodiment of the present invention.

### DETAILED DESCRIPTION

These and other objects, features and advantages of the present invention will be made clear by describing example embodiments of the present invention below. It is important to understand that the present invention may be embodied in many alternate forms and should not be construed as limited to the example embodiments set forth herein.

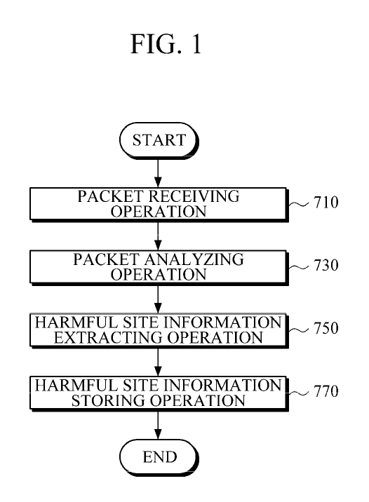

FIG. 1 is a flowchart illustrating a harmful information collecting method according to an embodiment of the present invention.

The harmful information collecting method may include a packet receiving operation 710 of receiving a plurality of packets collected from at least one packet collecting unit; a packet analyzing operation 730 of analyzing whether the received packets include harmful information; a harmful site information extracting operation 750 of extracting information on harmful sites from which the corresponding packets are transmitted, if the analyzed packets include harmful information; and a harmful site information storing operation 770 of storing the extracted information on harmful sites in a database.

The packet receiving operation 710 includes receiving a plurality of packets collected by at least one packet collecting unit. The packet collecting unit may be connected to an arbitrary network which is a harmfulness monitoring target to collect packets in real time. According to an embodiment of the present invention, the packet collecting unit may be realized by a server in a Peripheral Component Interconnect (PCI)-based network. Further, a proper device dedicated to packet collection may be used depending on the capacity of the used network.

At least one packet collecting unit connected to an arbitrary network may collect a plurality of packets transmitted from the network in real time. The plurality of packets may mean a number of packets that can be used as big data. In the packet receiving operation 710, a plurality of packets may be received from at least one packet collecting unit in real time. The number of arbitrary networks that packets collecting target may be determined as necessary.

The big data may mean a large-volume typical or atypical data set that exceeds capabilities of a conventional database management tool for data collection, storage, management, and analysis, and of technology for extracting values from the data and analyzing the result.

In the packet analyzing operation 730, whether the received packets include harmful information may be analyzed. The harmful information refers to illegal adult material or the like. Harmfulness analysis may be performed on a plurality of packets received in real time from a packet collecting unit. Known classifications and analysis algorithms may be used for the harmfulness analysis. According to an embodiment of the present invention, harmfulness classifications by the multiclass Support Vector Machine (SVM) may be used for harmfulness analysis.

In the harmful site information extracting operation 750, information on harmful sites from which the corresponding packets are transmitted may be extracted, if the analyzed packets include harmful information. According to an embodiment of the present invention, header parts of the packets including harmful information may be analyzed to extract information such as addresses of the sites corresponding to sources of the packets.

In the harmful site information storing operation 770, the extracted information on harmful sites may be stored in the database. The information on the sites including harmful information may be collected by storing the information on harmful sites.

According to an aspect of the present invention, the packet receiving operation 710 in the harmful information collecting method may include receiving metadata of the packets collected under the collection control based on a predetermined policy by at least one packet collecting unit in real time. The packet collecting unit that collects packets from an arbitrary network may collect packets and transmit the collected packets to a packet analyzing unit. Otherwise, the packet collecting unit may extract matadata from the packets collected according to a predetermined policy and transmit the extracted metadata to the packet analyzing unit.

The collection control based on the predetermined policy may refer to determining a policy for determining specific information to be extracted from a collected packet in advance. In the present invention, the collection control based on the predetermined policy is to collect a plurality of packets corresponding to big data and to analyze harmfulness. When packets are collected for large-volume processing, particular metadata in a packet may be extracted. According to an embodiment, metadata including only TCP headers extracted from header parts of the packets may be transmitted to the packet analyzing unit.

Herein, the metadata is structured data about data, and may refer to data that describes other data. The metadata may correspond to data assigned to contents according to fixed rules in order to effectively find and use desired information among a large volume of other information. The metadata may include a position and details of the contents, information on an author, terms of rights, usage conditions, usage history, and the like.

The metadata is used for locating data quickly, and may function as an index of information in a computer. The packet analyzing unit may easily find harmful data included in a packet which is an analysis target using metadata.

According to an aspect of the present invention, in the packet analyzing operation 730 of the harmful information collecting method, the received packets may be reassembled in predetermined units so as to analyze whether the reassembled packets include harmful information or not. According to an embodiment of the present invention, the received packets may be reassembled in any units selected from flow units, protocol units, port units, and application units. However, the present invention is not limited thereto and the packets may be reassembled in other units as necessary for the analysis.

According to an aspect of the present invention, in the packet analyzing operation 730 of the harmful information collecting method, the harmfulness with respect to any one of text data, multimedia data, or image data included in the reassembled packets may be analyzed. In order to analyze harmfulness with respect to the text data, the multimedia data, or the image data included in the reassembled packets, known classifications and analysis algorithms may be used. According to an embodiment of the present invention, harmfulness classifications by the multiclass Support Vector Machine (SVM) may be used for harmfulness analysis.

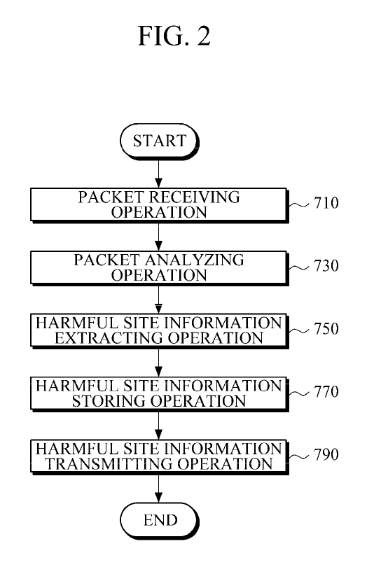

FIG. 2 is a flowchart illustrating a harmful information collecting method according to another embodiment of the present invention.

According to an aspect of the present invention, the harmful information collecting method may further include a harmful site information transmitting operation 790 of transmitting harmful site information stored in the database to at least one security apparatus. The information on harmful sites stored in the database is transmitted to a security apparatus on the network in real time in order to block the harmful sites. According to an embodiment of the present invention, the security apparatus may be a web application firewall, a harmful traffic controller, an Intrusion Detection System (IDS), an Intrusion Protection System (IPS), or the like. However, the present invention is not limited thereto, and may include an apparatus that can block harmful information.

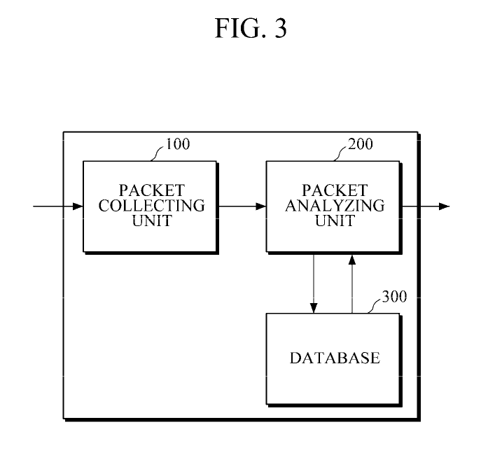

FIG. 3 is a block diagram illustrating a harmful information collecting apparatus according to an embodiment of the present invention.

According to another aspect of the present invention, the harmful information collecting apparatus may include at least one packet collecting unit 100 that collects a plurality of packets from at least one network, a packet analyzing unit 200 that receives the plurality of packets collected by the at least one packet collecting unit, analyzes the received packets, and extracts information on harmful sites from which the corresponding packets are transmitted, if the analyzed packets include harmful information, and a database 300 that stores the extracted information on harmful sites.

The at least one packet collecting unit 100 may collect a plurality of packets from at least one network. The packet collecting unit 100 may collect a plurality of packets from an arbitrary network in real time. According to an embodiment of the present invention, the packet collecting unit 100 may be realized by a server using a Peripheral Component Interconnect (PCI)-based network. Otherwise, a proper device dedicated to packet collection may be used depending on the capacity of the used network.

The at least one packet collecting unit 100 connected to an arbitrary network may collect the plurality of packets transmitted from the network in real time. The plurality of packets may mean a number of packets that can be used as big data. The number of arbitrary networks from which packets are collected may be determined as necessary.

The packet analyzing unit 200 may receive the plurality of packets collected by the at least one packet collecting unit 100, analyze the received packets, and extract information on harmful sites from which corresponding packets are transmitted, if the analyzed packets include harmful information. The harmful information may refer to illegal adult material and the like.

The packet analyzing unit 200 may analyze harmfulness with respect to a plurality of packets received from the packet collecting unit 100 in real time. Known classifications and analysis algorithms may be used for the harmfulness analysis. According to an embodiment of the present invention, harmfulness classifications by the multiclass Support Vector Machine (SVM) may be used for harmfulness analysis.

If the analyzed packets include harmful information, information on harmful sites from which corresponding packets are transmitted may be extracted. According to an embodiment of the present invention, header parts of the packets including harmful information may be analyzed to extract information such as addresses of sites corresponding to the sources of the corresponding packets.

The extracted information on harmful sites may be stored in the database 300. The information on harmful sites is stored in the database 300 so that the information on sites including harmful information may be collected.

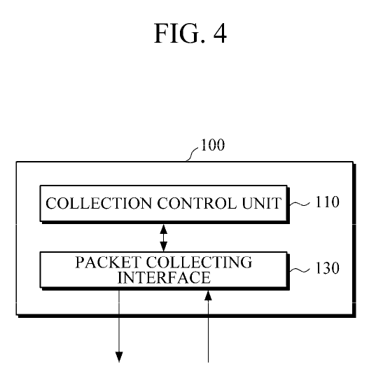

FIG. 4 is a block diagram illustrating a packet collecting unit according to an embodiment of the present invention.

According to an aspect of the present invention, the packet collecting unit 100 of the harmful information collecting apparatus may include a collection control unit 110 that controls a packet collecting interface according to a predetermined policy, and a packet collecting interface 130 that collects packets under the control of the collection control unit, extracts metadata of the collected packets, and transmits the metadata to the packet analyzing unit.

The collection control unit 110 may control the packet collecting interface according to the predetermined policy. When collecting a plurality of packets from an arbitrary network, the collection control unit 110 may control the packet collecting interface 130 according to the predetermined policy to collect packets. According to an embodiment of the present invention, the collection control unit 110 may control the packet collecting interface 130 so that metadata of the collected packets is extracted by the collection control based on the predetermined policy.

The collection control based on the predetermined policy may refer to determining a policy for determining specific information to be extracted from collected packets in advance. In the present invention, the collection control based on the predetermined policy is to collect a plurality of packets corresponding to big data and to analyze harmfulness in real time. When packets are collected, particular metadata in the packets are extracted so that large-volume data can be processed effectively. According to an embodiment of the present invention, the collection control unit 110 may control the packet collecting interface 130 so that metadata obtained by extracting only TCP header parts from header parts of the packets is transmitted to the packet analyzing unit.

The packet collecting interface 130 may collect packets under the control of the collection control unit, extract metadata of the collected packets, and transmit the extracted metadata to the packet analyzing unit. According to an embodiment of the present invention, the packet collecting interface 130 may include an Ethernet interface or various interfaces. The collection of packets and the transmission to the packet analyzing unit may be performed in real time.

According to an embodiment of the present invention, the packet collecting unit 100 may be realized with a capture card without the collection control unit 110. Otherwise, the packet collecting unit 100 may use a packet-dedicated card using a programmable network processor. Whether to include the collection control unit 110 may be determined according to a capacity of the network to be analyzed.

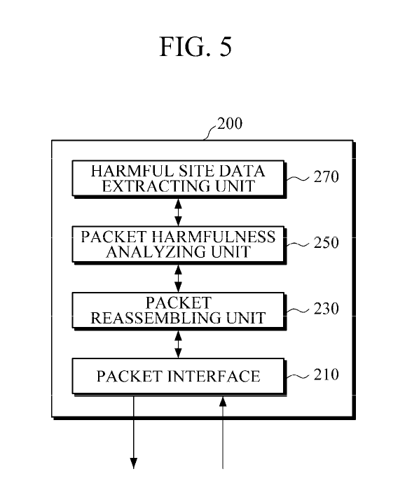

FIG. 5 is a block diagram illustrating a packet analyzing unit according to an embodiment of the present invention.

According to an aspect of the present invention, the packet analyzing unit 200 of the harmful information collecting apparatus may include a packet interface 210 that receives a plurality of packets from at least one packet collecting unit, a packet reassembling unit 230 that reassembles the received packets in predetermined units for analyzing the received packets, a packet harmfulness analyzing unit 250 that analyzes the harmfulness of the reassembled packets, and a harmful site data extracting unit 270 that extracts information on the sites from which the corresponding packets are transmitted, if the analyzed reassembled packets include harmful information.

The packet interface 210 may receive a plurality of packets from the at least one packet collecting unit 100. Interfaces of various standards may be used as the packet interface 210. According to an embodiment, the packet interface 210 may be an Ethernet interface.

The packet reassembling unit 230 may reassemble the received packets in predetermined units for analyzing the received packets. The packet reassembling unit 230 may reassemble the received packets in predetermined units as necessary. According to an embodiment of the present invention, the received packets may be reassembled in any units selected from flow units, protocol units, port units, and application units. However, the present invention is not limited thereto and the packets may be reassembled in other units as necessary for the analysis.

The packet harmfulness analyzing unit 250 may analyze harmfulness of the reassembled packets in real time. The packet harmfulness analyzing unit 250 may store classifications and analysis algorithms for harmfulness analysis. The packet harmfulness analyzing unit 250 may analyze harmfulness with respect to the plurality of packets using the stored classifications and analysis algorithms. According to an embodiment of the present invention, harmfulness classifications by the multiclass Support Vector Machine (SVM) may be used for harmfulness analysis. However, the present invention is not limited thereto and known classifications and analysis algorithms may be used for the harmfulness analysis.

If the analyzed reassembled packets include harmful information, the harmful site data extracting unit 270 may extract information on the sites from which the corresponding packets are transmitted. According to an embodiment of the present invention, header parts of the packets including harmful information are analyzed so that information such as addresses of the sites corresponding to the sources of the corresponding packets can be extracted.

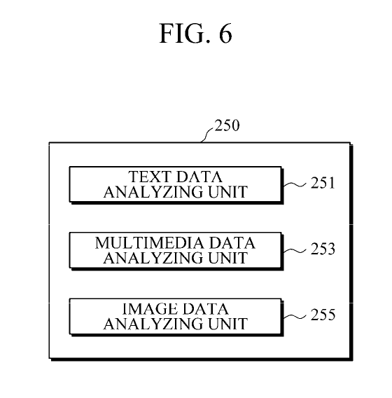

FIG. 6 is a block diagram illustrating a packet harmfulness analyzing unit according to an embodiment of the present invention.

According to an aspect of the present invention, the packet harmfulness analyzing unit 250 of the packet analyzing unit includes a text data analyzing unit 251 that analyzes harmfulness with respect to text data included in reassembled packets, a multimedia data analyzing unit 253 that analyzes harmfulness with respect to multimedia data included in the reassembled packets, and an image data analyzing unit 255 that analyzes harmfulness with respect to image data included in the reassembled packets. The analysis of the harmfulness may be performed in real time.

The text data analyzing unit 251 may analyze harmfulness with respect to the text data included in the reassembled packets. According to an embodiment of the present invention, the text data analyzing unit 251 may be realized with a text analysis engine. In order to analyze harmfulness with respect to the text data included in the reassembled packets, the text data analyzing unit 251 may use known classifications and analysis algorithms.

The multimedia data analyzing unit 253 may analyze harmfulness with respect to the multimedia data included in the reassembled packets. According to an embodiment of the present invention, the multimedia data analyzing unit 253 may be realized with a multimedia analysis engine. In order to analyze harmfulness with respect to the multimedia data included in the reassembled packets, the multimedia data analyzing unit 253 may use known classifications and analysis algorithms.

The image data analyzing unit 255 may analyze harmfulness with respect to the image data included in the reassembled packets. According to an embodiment of the present invention, the image data analyzing unit 255 may be realized with an image analysis engine. In order to analyze harmfulness with respect to the image data included in the reassembled packets, the image data analyzing unit 255 may use known classifications and analysis algorithms.

According to an embodiment of the present invention, the packet interface 210 of the packet analyzing unit transmits information on harmful sites stored in the database 300 to at least one security apparatus in real time. Accordingly, the sites determined to be harmful may be blocked in real time. According to an embodiment of the present invention, the security apparatus may be a web application firewall, a harmful traffic controller, an Intrusion Detection System (IDS), an Intrusion Protection System (IPS), or the like. However, the present invention is not limited thereto, and may include an apparatus that can block harmful information.

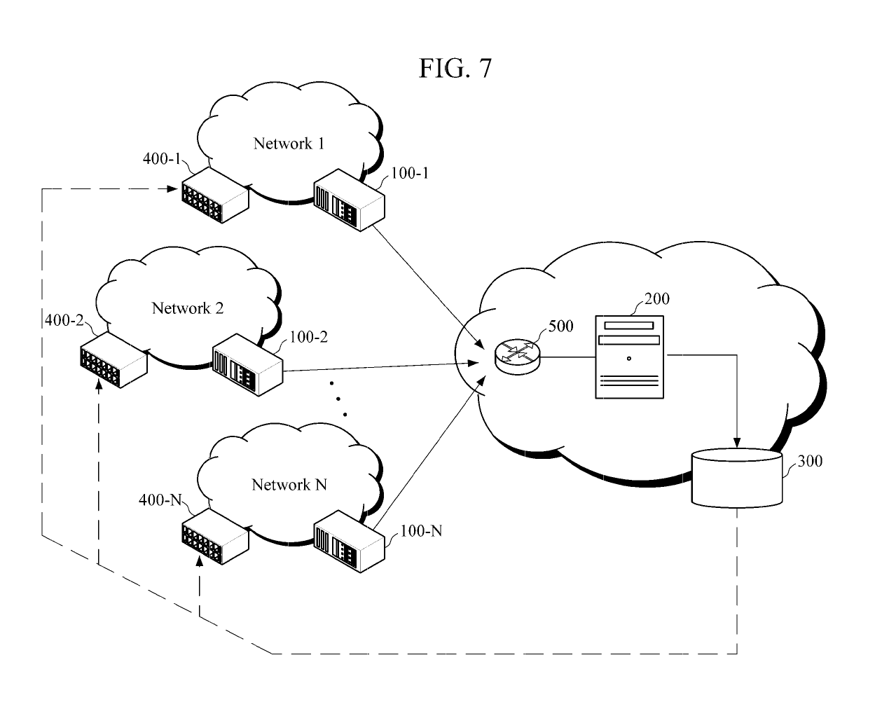

FIG. 7 is a diagram illustrating a structure of a harmful information collecting apparatus according to an embodiment of the present invention.

The packet collecting unit 100 may be a network packet collecting unit that collects packets from an arbitrary network in real time. According to an embodiment of the present invention, a server using a PCI-based network may be used as a packet collecting unit. Otherwise, an apparatus dedicated to packet collection may be used. “N” in FIG. 7 is an arbitrary positive integer and refers to the number of networks to be targets of harmfulness analysis. In FIG. 7, it is illustrated that one network corresponds to one packet collecting unit, but the present invention is not limited thereto and one or more packet collecting units may collect packets.

The packet analyzing unit 200 may select a network to be connected through a router 500.

The packet analyzing unit 200 may analyze Internet packets with an analysis server including a network interface in real time to locate harmful images and extract harmful sites. The extracted information may be stored in the database 300. The extracted information may be updated in a security apparatus 400 in real time. In FIG. 7, it is illustrated that one security apparatus corresponds to one network, but the invention is not limited thereto and one or more security apparatuses may block harmful sites.

The collection control unit 110 of the packet collecting unit 100 may communicate with the packet analyzing unit 200. The collection control unit 110 may control the packet collecting interface 130. The packet collecting interface may have various interfaces such as an Ethernet interface and may transmit and receive packets.

The packet collecting interface 130 may determine the nature of the packets collected by the collection control unit 110. A capture card without a collection control unit or a packet-dedicated card using a programmable network processor may be used as the packet collecting unit 100. This may be determined according to the capacity of the used network.

According to an embodiment of the present invention, an example of the collection control may be extracting only TCP header information and transmitting the extracted TCP header information to the packet analyzing unit 200. However, the present invention is not limited thereto and the collection control may be performed as necessary. Various kinds of metadata relating to Internet packets may be extracted by the collection control. Since a collection apparatus performs policy-based collection, a large volume of Internet traffic is processed as big data to obtain harmful information.

The packet analyzing unit 200 may analyze packets received through the distributed packet collecting unit 100. The packets are received through the packet interface 210. The packet interface may be realized by interfaces of various standards. According to an embodiment of the present invention, the packet interface may be a 10 Gbps of Ethernet interface.

The received packets may be reassembled in any units among flow units, protocol units, port units, and application units through the packet reassembling unit 230 in real time. However, the present invention is not limited thereto and the packets may be reassembled in other units as necessary for the analysis.

The reassembled packets are input from the packet harmfulness analyzing unit 250 to the text data analyzing unit 251, the multimedia data analyzing unit 253, and the image data analyzing unit 255 so that harmfulness thereof may be determined. The harmful site data extracting unit 270 may extract information about which websites and which Internet addresses the flow of packets whose harmfulness is determined is related to. The extracted information may be stored in the database 300.

There are various kinds of harmfulness analyzing methods. According to an embodiment, harmfulness classifications by the multiclass Support Vector Machine (SVM) may be used for harmfulness analysis. However, the present invention is not limited thereto and known classifications and analysis algorithms may be used for the harmfulness analysis. In the packet analyzing unit, the accuracy of the harmfulness determination may be increased by the correlation of values deduced from the classification method and high-volume nature of an input data distribution.

In FIG. 7, the packet collecting unit 100, the packet analyzing unit 200, and the database 300 are illustrated as separate components, but the present invention is not limited thereto and the packet collecting unit 100, the packet analyzing unit 200, and the database 300 may be realized as one apparatus.

The disclosed harmful information collecting method and apparatus may collect information on harmful sites more accurately by collecting a plurality of packets and analyzing harmfulness.

Further, the disclosed harmful information collecting method and apparatus may analyze large-volume Internet traffic in real time using a dispersion structure to extract harmful information.

Further, the disclosed harmful information collecting method and apparatus may perform policy-based packet collection according to a predetermined policy.

Further, the disclosed harmful information collecting method and apparatus may perform harmfulness analysis with respect to one of text, images, and multimedia, in a packet.

Further, the disclosed harmful information collecting method and apparatus may analyze a correlation with respect to large-volume packets to increase accuracy of harmfulness determination.

While the present invention has been described with reference to example embodiments thereof, those of ordinary skill in the art will recognize that various changes and modifications to the embodiments described herein can be made without departing from the spirit and scope of the invention as defined by the appended claims and their equivalents.

What is claimed is:

1. A harmful information collecting method, comprising:
receiving a plurality of packets collected by at least one packet collecting unit;
analyzing whether the received packets include harmful information;
extracting information on harmful sites from which corresponding packets are transmitted if the analyzed packets include harmful information; and
storing the extracted information on harmful sites in a database.

2. The harmful information collecting method of claim 1, wherein the receiving of the packets includes receiving metadata of the packets collected under collection control based on a predetermined policy by at least one packet collecting unit in real time.

3. The harmful information collecting method of claim 1, wherein the analyzing of the packets includes reassembling the received packets in predetermined units and analyzing whether the reassembled packets include harmful information.

4. The harmful information collecting method of claim 3, wherein the analyzing of the packets includes analyzing harmfulness with respect to any one of text data, multimedia data, or image data included in the reassembled packets.

5. The harmful information collecting method of claim 1, further comprising:
transmitting the information on harmful sites stored in the database to at least one security apparatus.

6. A harmful information collecting apparatus, comprising:
at least one packet collecting unit configured to collect a plurality of packets from at least one network;
a packet analyzing unit configured to receive the plurality of packets collected by the at least one packet collecting unit, analyze the received packets, and extract information on harmful sites from which corresponding packets are transmitted if the analyzed packets include harmful information; and
a database configured to store the extracted information on harmful sites.

7. The harmful information collecting apparatus of claim 6, wherein the packet collecting unit includes:
a collection control unit configured to control a packet collecting interface according to a predetermined policy; and
the packet collecting interface configured to collect packets under the control of the collection control unit, extract metadata of the collected packets, and transmit the extracted metadata to the packet analyzing unit.

8. The harmful information collecting apparatus of claim 6, wherein the packet analyzing unit includes:
a packet interface configured to receive a plurality of packets from at least one packet collecting unit;
a packet reassembling unit configured to reassemble the received packets in predetermined units for analyzing the received packets;
a packet harmfulness analyzing unit configured to analyze harmfulness of the reassembled packets; and
a harmful site data extracting unit configured to extract information on sites from which corresponding packets are transmitted, if the analyzed reassembled packets include harmful information.

9. The harmful information collecting apparatus of claim 8, wherein the packet harmfulness analyzing unit includes:
a text data analyzing unit configured to analyze harmfulness with respect to text data included in the reassembled packets;
a multimedia data analyzing unit configured to analyze harmfulness with respect to multimedia data included in the reassembled packets; and
an image data analyzing unit configured to analyze harmfulness with respect to image data included in the reassembled packets.

10. The harmful information collecting apparatus of claim 8, wherein the packet interface transmits the information on harmful sites stored in the database to at least one security apparatus.
